(19) United States
(12) Patent Application Publication
(10) Pub. No.: US 2013/0260082 A1
(43) Pub. Date: Oct. 3, 2013

(54) PROTECTIVE FILM FOR ELECTRONIC DEVICE

(71) Applicants: SHENG-CHIEN CHAN, TAOYUAN COUNTY (TW); CHENG-WEN YU, TAOYUAN COUNTY (TW)

(72) Inventors: SHENG-CHIEN CHAN, TAOYUAN COUNTY (TW); CHENG-WEN YU, TAOYUAN COUNTY (TW)

(73) Assignee: YUXI TECHNOLOGY CO., LTD., TAOYUAN COUNTY (TW)

(21) Appl. No.: 13/534,056

(22) Filed: Jun. 27, 2012

(30) Foreign Application Priority Data
Mar. 30, 2012 (TW) 101205925

(51) Int. Cl. B32B 3/02; B32B 7/02; C09J 7/02; D06N 7/04

(52) U.S. Cl. 428/81; 428/141; 428/151

(57) ABSTRACT

The present invention relates to a protective film for electronic device. The protective film comprises a protective-film body and a first microstructure layer. The protective-film body has a first surface and a second surface. The first microstructure layer is disposed on the first surface of the protective-film body. The second surface of the protective-film body covers the surface of an electronic device. The hardness of the protective film is between 1 H and 12 H. Thanks to it high surface hardness, the protective film according to the present invention has superior wear and scrape resistance. Thereby, the life time of the protective film is extended and hence ensuring protection of the surface of the electronic device.

### FIELD OF THE INVENTION

The present invention relates generally to a protective film, and particularly to a protective film for electronic device.

### BACKGROUND OF THE INVENTION

With progress in technologies, modern people can hardly live without electronic devices. Currently, there are many kinds of mobile electronic devices in the market, for example, mobile phones, PDAs, GPS, e-books, notebook computers, MP3 and MP4 players, and digital cameras. They all have displays, among which are even designed in touch sensing styles. Because the display will wear gradually during long-term usage of these mobile electronic devices, protective films are designed for protecting the displays. Modern protective films for displays are mostly processed on the outer surface of the displays. The processing methods include film attachment or transfer film treatment on the surface of the displays of mobile electronic devices. After the process, the displays mostly have the functions of beautification, no residual glue, easy rework, fundamental dust repellence, and fundamental scrape resistance. Nonetheless, current protective films still cannot achieve high wear resistance while maintaining shiny and novel appearance. How to solve the problem of wear resistance on the display of mobile electronic devices effectively has become the most important subject.

The hardness of the protective films for electronic device according to prior art is not sufficient. Thereby, the protective films are vulnerable to scrapes or damages, which shorten the life time of the protective films and prevent them from protecting the surfaces of electronic devices effectively. Accordingly, the present invention provides a protective film with high hardness for protecting the surface of electronic device and thus solving the problem described above.

### SUMMARY

An objective of the present invention is to provide a protective film for electronic device. The protective film according to the present invention has high hardness, enabling superior wear and scrape resistance. Thereby, the life time of the protective film can extended and the surface of electronic devices can be protected with certainty.

The present invention provides a protective film for electronic device, which protective film comprises a protective-film body and a first microstructure layer. The protective-film body has a first surface and a second surface; the first microstructure layer is disposed on the first surface. The second surface of the protective-film body covers the surface of an electronic device. The hardness of the protective film is between 1 H and 12 H.

### BRIEF DESCRIPTION OF THE DRAWINGS

FIG. 1 shows a cross-sectional view of the protective film according a first embodiment of the present invention;

FIG. 2 shows a usage status view of the protective film according the first embodiment of the present invention;

FIG. 3 shows an enlarged view of the “a” region in FIG. 1 according to the present invention;

FIG. 4 shows a cross-sectional view of the protective film according a second embodiment of the present invention;

FIG. 5A and FIG. 5B show other enlarged views of the “a” region in FIG. 1 according to the present invention;

FIG. 6 shows a cross-sectional view of the protective film according a fourth embodiment of the present invention;

FIG. 7 shows a cross-sectional view of the adhesive structure according a fifth embodiment of the present invention;

FIG. 8 shows a cross-sectional view of the adhesive structure according a sixth embodiment of the present invention;

FIG. 9 shows a cross-sectional view of the adhesive structure according a seventh embodiment of the present invention; and

FIG. 10 shows a cross-sectional view of the adhesive structure according an eighth embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The hardness of the protective films for electronic device according to the prior art is not sufficient, and hence making the protective films vulnerable to scrapes or damages, which shorten their life time and make them unable to protect the surface of electronic device effectively. Accordingly, the present invention provides a protective film with high hardness for protecting the surface of electronic device.

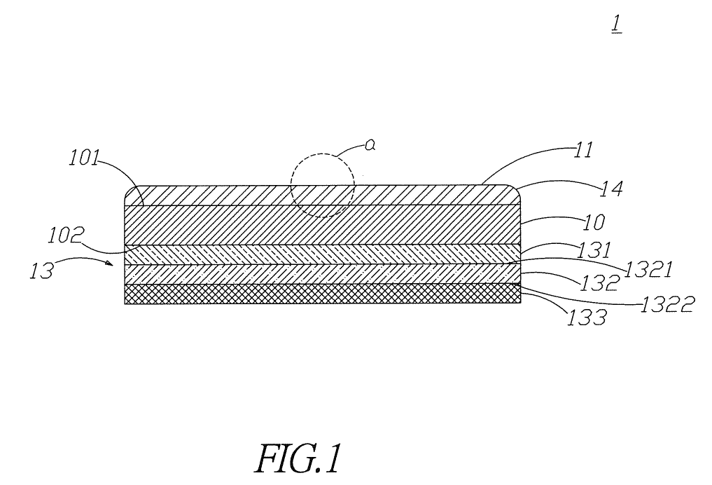

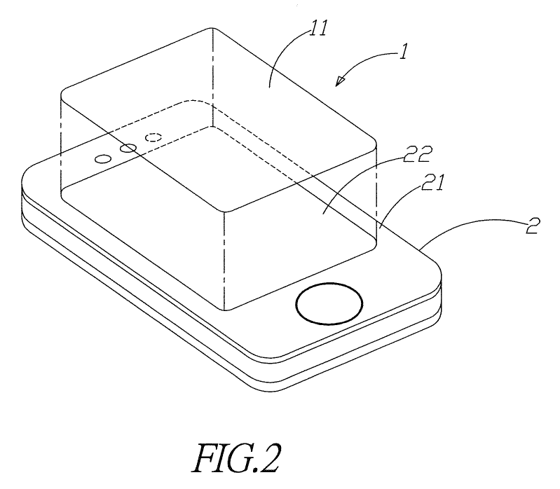

FIG. 1 and FIG. 2 show a cross-sectional and a usage status view of the protective film according a first embodiment of the present invention. As shown in the figures, the present embodiment provides a protective film 1 for electronic device. The protective film 1 is mainly attached to a surface 21 of an electronic device 2 to be protected. The surface 21 to be protected 21 usually corresponds to the display area 22 of the electronic device 2. The surface hardness of the protective film 1 according to the present embodiment can exceed 1 H, or even can reach as high as 12 H. Thereby, compared to the protective film according to the prior art, the protective film 1 according to the present embodiment has better wear and scrape resistance. Hence, the life time of the protective film 1 is extended for protecting the surface 21 of the electronic device 2 effectively and avoiding scrapes or damages on the surface 21 of the electronic device 2. Besides, the protective film 1 according to the present embodiment is very light and thin with a thickness between 0.01 and 0.5 centimeter and transparency of 98%.

The protective film 1 according to the present embodiment comprises a protective-film body 10 and a first microstructure layer 11. The protective-film body 10 has a first surface 101 and a second surface 102. The first microstructure layer 11 is disposed on the first surface 101. The manufacturing method of the protective film 1 according to the present embodiment is the gel injection method. According to the method, a first mold and a second mold are provided first. Then coat a first optical gel on the inner surface of the first mold for forming the first microstructure layer 11. Next, a second optical gel is injected between the first optical gel and the second mold for forming the protective-film body 10. Finally, the first and second molds are detached and thus forming the protective film 1.

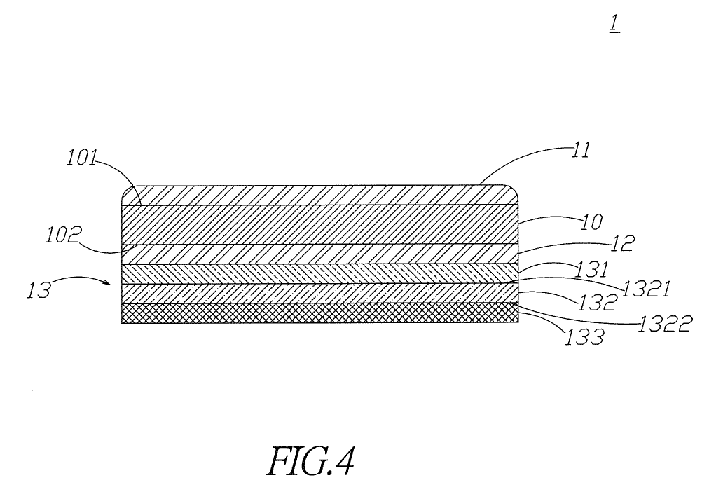

The gel injection method for manufacturing the protective film 1 according to the present embodiment is different from the stamping method for manufacturing the protective film according to the prior art. Owing to the manufacturing method, the edges of the protective film according to the prior are is so sharp that users are vulnerable to scrapes. On the contrary, the protective film 1 according to the present embodiment adopts the gel injection method and the edges, which contain holes, of the protective film 1 can be C-type processed. Thereby, the edge of the first microstructure layer 11 of the protective film 1 have a round corner 14, which prevent the protective film 3 from scraping users. In addition, the first microstructure layer 11 is disposed on the first surface 101 of the protective-film body 10 only according to the present embodiment. A second microstructure layer 12 can also be disposed on the second surface 102 of the protective-film body 10 (refer to FIG. 4). The details will not be described further.

The reason why the protective film 1 according to the present embodiment has high hardness is owing to the first microstructure layer 11 on the first surface 101 of the protective-film body 10. When the second surface 102 of the protective-film body 10 is attached to the surface 21 of the electronic device 2, the user operates on the surface of the protective film 1 having the first microstructure layer 11. Thanks to the high hardness property of the protective film 1, scrapes or damages on the protective film 1 caused by the user can be avoided. Thereby, the life time of the protective film 1 can be extended and the surface 21 of the electronic device 2 can be further protected.

Because the protective film 1 according to the present embodiment covers the display area 22 of the electronic device 2, the material of the protective-film body 10 according to the present embodiment is transparent acrylic and is an optical gel. Here, the refractivity of the protective-film body 10 is less than that of the surface 21 of the electronic device 2. When the electronic device 2 produces a display light source, the display light source tends to transmit the protective-film body 10. The protective-film body 10 keeps the display light source refracting between the protective film 1 and the surface 21 of the electronic device 2. Thereby, the brightness and color saturation of the electronic device 2 are enhanced, and thus improving the display quality of the electronic device 2. It is known from above that by special optical designs on the protective-film body 10 or the first microstructure layer 11, the brightness and color saturation of the electronic device 2 are enhanced. Moreover, the material of the protective-film body 10 according to the present embodiment can also be glass, PET, or other transparent plastics. The details will not be described further.

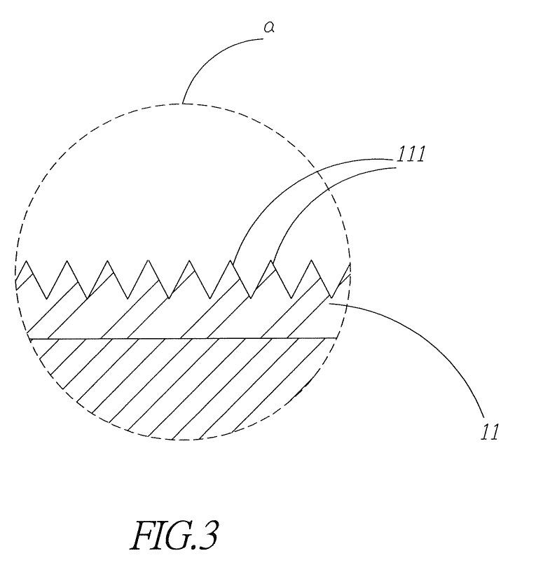

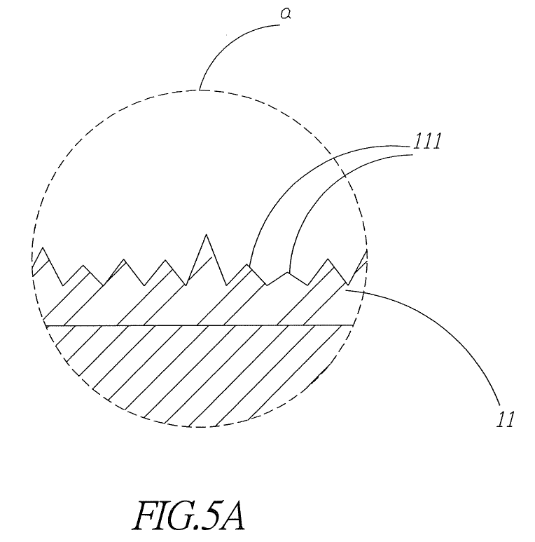

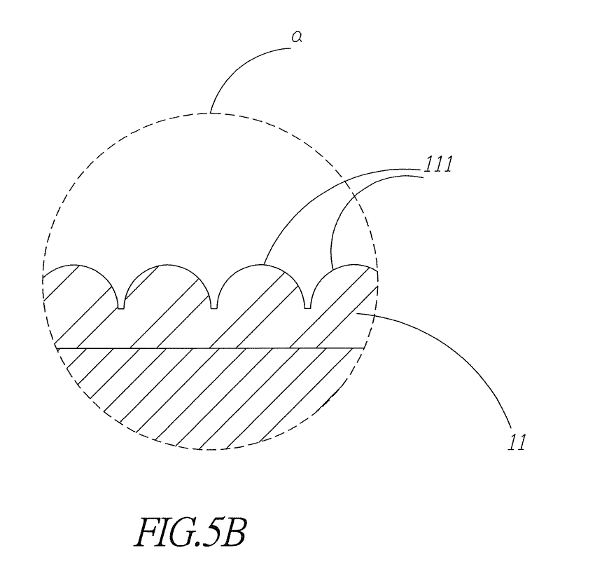

Refer again to FIG. 1. The first microstructure layer 11 according to the present embodiment is comprised by the first optical gel. The first microstructure layer 11 has at least a three-dimensional pattern 111. Namely, the surface of the first microstructure layer 11 is lumpy. The cross-section of the three-dimensional pattern Ill according to the present embodiment is isosceles right triangles. The three-dimensional pattern 111 is arranged in order (refer to FIG. 3, which shows an enlarged view of the “a” region in FIG. 1). It can also be arranged irregularly (refer to FIG. 5A, which shows an enlarged view of the “a” region in FIG. 1). Besides, the cross-section of the three-dimensional pattern 111 can also be semicircles (refer to FIG. 5B) or other geometric shapes. The three-dimensional pattern 111 of the first microstructure layer 11 can be mat, hair-structured, leather-grained, woven-grained, carbon-fiber-grained, or concentric-circle-grained for achieving various functions. The details will not be described further. In addition, since the first microstructure layer 11 is specially designed, the anti-peep effect can be achieved. In other words, the viewing angle is between 30 to 100 degrees, which prevent others from peeping at the display of the electronic device 2. Furthermore, the structure of the second microstructure layer 12 in FIG. 4 is identical to that of the first microstructure layer 11. Its details will not be described further.

The first microstructure layer 11 is comprised by the first optical gel. During the process of manufacturing the protective film 1, at least an additive can be added into the first optical gel. For example, by adding anti-reflection agent, the first microstructure layer 11, and hence the protective film 1, can have anti-reflection capability. By adding water repellent agent, the first microstructure layer 11, and hence the protective film 1, can have water repellent capability. By adding anti-germ agent, the first microstructure layer 11, and hence the protective film 1, can have anti-germ capability. Besides, other additives include anti-glare agent, polish enhancer, anti-UV agent, anti-radiation agent, anti-mist agent, anti-stain agent, or anti-oil agent. Appropriate additives can be added to the first optical gel according to user's requirements to make the protective film 1 meet the user's needs.

The protective film 1 according to the present embodiment is fixed on the surface 21 of the electronic device 2 by using an adhesive structure 13. The adhesive structure 13 is disposed on the second surface 102 of the protective-film body 10, and comprises a glue layer 131, a substrate layer 132, and an adhesive layer 133. The substrate layer 132 has a first surface 1321 and a second surface 1322. The glue layer 131 is disposed on the first surface 1321 o the substrate layer 132. The adhesive layer 133 is disposed on the second surface 1322 of the substrate layer 132. The glue layer 131 adheres to the second surface 102 of the protective-film body 10. The adhesive layer 133 adheres to the surface 21 of the electronic device 2. The adhesive layer 133 according to the present embodiment is silica gel. Because silica gel can be reused, the protective film 1 can be detached from and re-attached to the surface 21 of the electronic device 2. Namely, the protective film 1 can be reused. Of course, the adhesive layer 133 can adopt other optical gel. The details will not be described. The adhesive structure 13 according to the present embodiment is comprised of optical gel. That is to say, the glue layer 131, the substrate layer 132, and the adhesive layer 133 are al optical gels. According to the present embodiment, the material of the glue layer 131 is acrylic gel and the material of the substrate layer 132 is PET gel. This is only an embodiment of the present invention. The present invention is not limited to the embodiment.

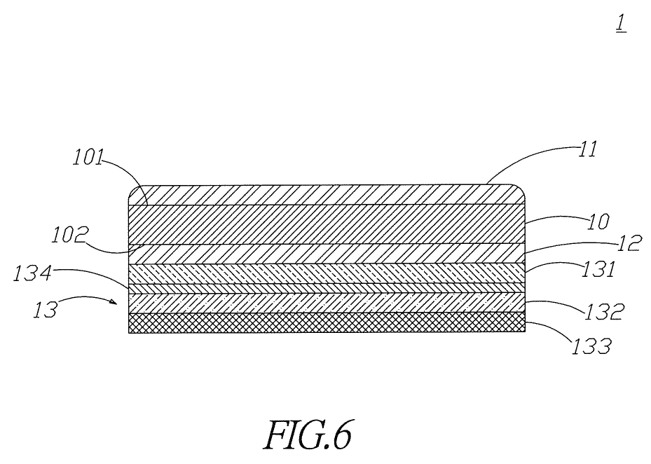

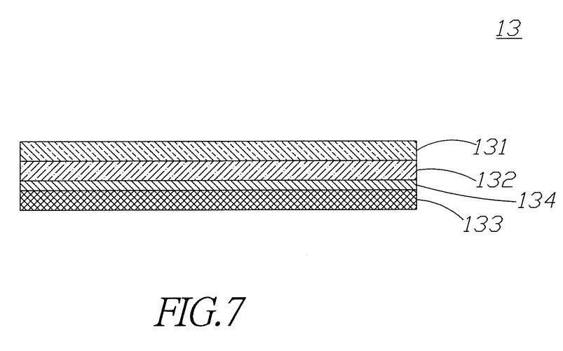

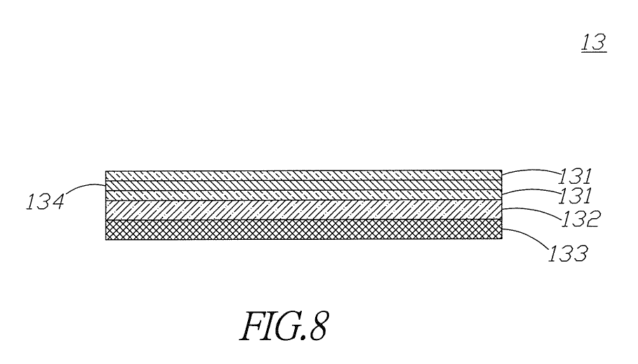

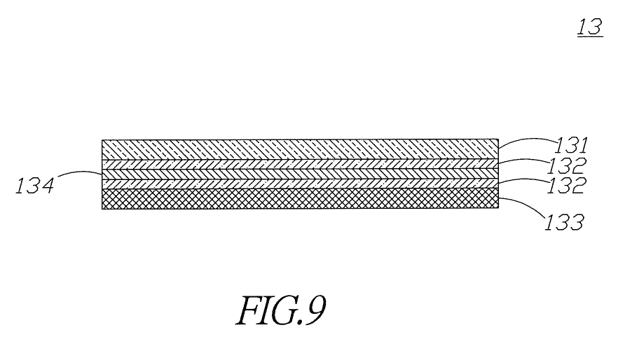

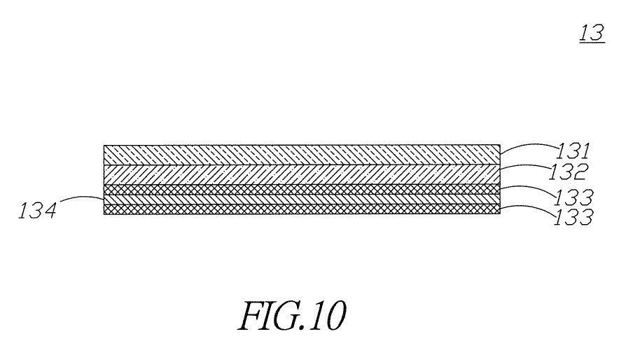

FIG. 6 shows a cross-sectional view of the protective film according a fourth embodiment of the present invention. As shown in the figure, the protective film 1 according to the present embodiment can attach to the touch display panel of the electronic device 2. For maintaining good touch operations, the adhesive structure 13 of the protective film 1 further comprises a conductive layer 134 disposed between the glue layer 131 and the substrate layer 132. The conductive layer 134 in the protective film 1 conducts electrically with the surface 21 of the electronic device 2 for increasing conductivity of the protective film 1 and hence ensuring normal operations of the electronic device 2 by the user through the protective film I. Alternatively, the conductive layer 134 can also be disposed between the substrate layer 132 and the adhesive layer 133 (refer to FIG. 7), or embedded in the glue layer 131, the substrate layer 132, or the adhesive layer 133 (refer to FIG. 8-10). The details will not be described further.

To sum up, the present invention provides a protective film for electronic device. The protective film according to the present invention has high surface hardness. Compared to the protective film according to the prior art, the protective film according to the present invention has superior wear and scrape resistance. Thereby, the life time of the protective film can be extended and thus ensuring protection of the surface of the electronic device. In addition, the protective film can be adhered to various electronic devices repeatedly and hence achieving the purpose of reuse. Moreover, the protective film according to the present invention is very light and thin, making it not affecting the touch operations of a user on the electronic device. Besides, the protective film according to the present invention further has a conductive layer for maintaining good touch operations. The protective film according to the present invention also enhances the brightness and display quality of the electronic device. Furthermore, the protective film according to the present invention has rounded edges for preventing the user from scrapes.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A protective film for electronic device, comprising:
a protective-film body, having a first surface and a second surface; and
a first microstructure layer, disposed on said first surface;
where said second surface of said protective-film body covers the surface of an electronic device, and the surface hardness of said protectively film is between 1 H and 12 H.

2. The protective film for electronic device of claim 1, wherein said protective-film body is an optical gel made of glass or acrylic material.

3. The protective film for electronic device of claim 1, wherein the refractivity of said protective-film body is less than the refractivity of said electronic device.

4. The protective film for electronic device of claim 1, wherein said first microstructure layer is an optical gel containing at least an additive.

5. The protective film for electronic device of claim 1, wherein said first microstructure layer includes at least a three-dimensional pattern in mat, hair-structured, leather-grained, woven-grained, carbon-fiber-grained, or concentric-circle-grained shape.

6. The protective film for electronic device of claim 5, wherein the cross-section of said three-dimensional pattern can be semicircular or isosceles right triangular.

7. The protective film for electronic device of claim 1, and further comprising an adhesive structure disposed on said second surface of said protective-film body and enabling said protective-film body to adhere to the surface of said electronic device.

8. The protective film for electronic device of claim 7, wherein said adhesive structure comprises:
a glue layer, disposed on said second surface of said protective-film body;
a substrate layer, disposed on said glue layer; and
an adhesive layer, disposed on said substrate layer, and adhering to the surface of said electronic device.

9. The protective film for electronic device of claim 8, wherein said adhesive structure further comprises a conductive layer disposed between said glue layer and said substrate layer.

10. The protective film for electronic device of claim 8, wherein said adhesive structure further comprises a conductive layer disposed between said adhesive layer and said substrate layer.

11. The protective film for electronic device of claim 8, wherein said adhesive structure further comprises a conductive layer embedded in said glue layer.

12. The protective film for electronic device of claim 8, wherein said adhesive structure further comprises a conductive layer embedded in said substrate layer.

13. The protective film for electronic device of claim 8, wherein said adhesive structure further comprises a conductive layer embedded in said adhesive layer.

14. The protective film for electronic device of claim 1, wherein said adhesive structure is an optical gel.

15. The protective film for electronic device of claim 1, and further comprising a second microstructure layer disposed on said second surface of said protective-film body.

16. The protective film for electronic device of claim 15, wherein said second microstructure layer is an optical gel containing at least an additive.

17. The protective film for electronic device of claim 15, wherein said second microstructure layer includes at least a three-dimensional pattern in mat, hair-structured, leather-grained, woven-grained, carbon-fiber-grained, or concentric-circle-grained shape.

18. The protective film for electronic device of claim 17, wherein the cross-section of said three-dimensional pattern can be semicircular or isosceles right triangular.

19. The protective film for electronic device of claim 1, wherein the thickness of said protective layer is between 0.01 and 0.5 centimeter, and the transparency of said protective layer is greater than 98%.

20. The protective film for electronic device of claim 1, wherein the edges of said first microstructure layer have a rounded angle.
